(19) United States
(12) Patent Application Publication
(10) Pub. No.: US 2012/0002174 A1
(43) Pub. Date: Jan. 5, 2012

(54) LIGHT SOURCE SYSTEM OF PICO PROJECTOR

(76) Inventors: SHIN-GWO SHIUE, Hu Kou Township (TW); David Tsai, Hu Kou Township (TW)

(21) Appl. No.: 12/828,259

(22) Filed: Jun. 30, 2010

(51) Int. Cl. G03B 21/14

(52) U.S. Cl. 353/31

(57) ABSTRACT

The a light source system of pico projector is composed of a light-emitting diode module, collimators, a lens array, magnification lenses, and an LCoS (light crystal on silicon) panel, arranged in sequence with appropriate spacing in-between. The light-emitting diode module, as the light source, emits red, green, and blue lights. The collimators convert light from the light-emitting diode module into collimated light. The lens array homogenizes the collimated light. The magnification lenses magnify the homogenized light from the lens array with a predetermined ratio onto the LCoS panel. The LCoS panel reflects and modulates the light to form an optic signal to be projected to a screen.

### (A) TECHNICAL FIELD OF THE INVENTION

The present invention generally relates to a light source system of projectors, and more particular to a light source engine for pico projectors.

### (B) DESCRIPTION OF THE PRIOR ART

A light source system for conventional large or small-medium projector comprises a hyperbolic lamp shade to focus and project diffused light. The lamp shade is bulky and cannot be applied to the light source system of pico projector. Therefore, in order to comply with the latest trend of downsized, light-weighted, and portable projectors, the lamp shade has to be improved.

Light emitting diodes (LEDs), due to the recent technology development, are highly efficient as light source. On the other hand, as green laser requires further breakthrough, integrating red, blue, green laser light is still difficult, and single laser chip package still suffers high cost and bulky dimension, LEDs remain the mainstream for light source. However, light from LEDs is more scattered and dispersed than laser light. Further, it is difficult to achieve uniform brightness when projecting image on the screen.

As such, the light source system of pico projector according to the present invention is able to concentrate light from the LEDs with about 120-degree scatter angle and project the concentrated light. This is a main feature of the present invention.

Concentrating scattered light and then projecting the light would still suffer non-uniformity as the image's center region is always brighter than the peripheral, due to inherent characteristic of light. Therefore, an LCoS (light crystal on silicon) panel is adopted to achieve uniform and bright images. This is another main feature of the present invention.

### SUMMARY OF THE INVENTION

The present invention provides a light source system of pico projector, which is composed of a light-emitting diode module, collimators, a lens array, magnification lenses, and an LCoS (light crystal on silicon) panel, arranged in sequence with appropriate spacing in-between, wherein the light-emitting diode module, as the light source, emits red, green, and blue lights.

The present invention provides a light source system of pico projector, which is composed of a light-emitting diode module, collimators, a lens array, magnification lenses, and an LCoS (light crystal on silicon) panel, arranged in sequence with appropriate spacing in-between, wherein the collimators, in a front-back sequential arrangement with appropriate spacing, convert light from the light-emitting diode module into collimated light.

The present invention provides a light source system of pico projector, which is composed of a light-emitting diode module, collimators, a lens array, magnification lenses, and an LCoS (light crystal on silicon) panel, arranged in sequence with appropriate spacing in-between, wherein the lens array homogenizes the collimated light.

The present invention provides a light source system of pico projector, which is composed of a light-emitting diode module, collimators, a lens array, magnification lenses, and an LCoS (light crystal on silicon) panel, arranged in sequence with appropriate spacing in-between, wherein the magnification lenses, in a front-back arrangement with appropriate spacing, magnify the homogenized light from the lens array with a predetermined ratio onto the LCoS panel.

The present invention provides a light source system of pico projector, which is composed of a light-emitting diode module, collimators, a lens array, magnification lenses, and an LCoS (light crystal on silicon) panel, arranged in sequence with appropriate spacing in-between, wherein the LCoS panel reflects and modulates the light to form an optic signal to be projected to a screen.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a conventional projector.

FIG. 2 is a schematic diagram showing the various components of a light source system of a pico projector according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

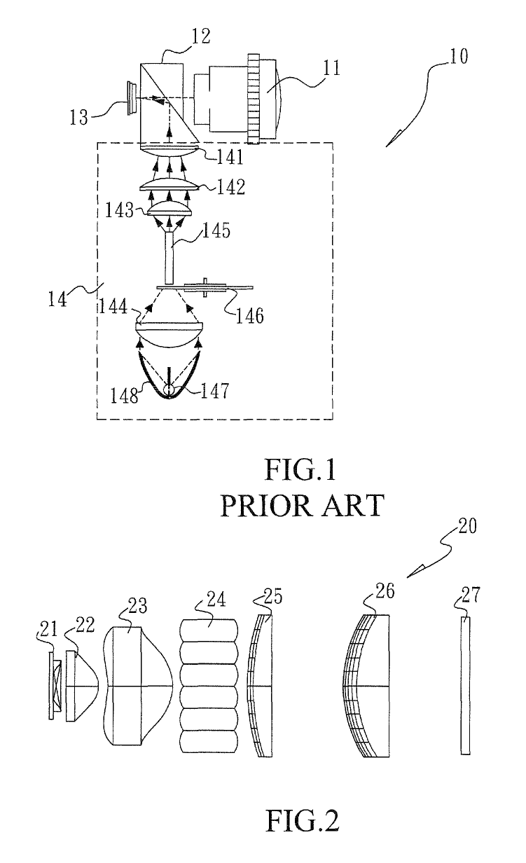

As shown in FIG. 1, a conventional projector 10 contains a projection lens 11, a total-internal-reflection prism 12, a digital pico reflection mirror 13, and a light source system 14. The light source system 14 contains at least four optical lenses 141, 142, 143, 144, an integration column 145, a red-green-blue, three-colored palette 146, and a lamp source 147 which requires a hyperbolic lamp shade 148 for concentrating light beams. The light source system 14 is therefore rather bulky and not appropriate for a pico projector's requirement for minimization.

FIG. 2 is a schematic diagram showing the various components of a light source system 20 of a pico projector according to the present invention. As illustrated, the light source system 20 contains a light-emitting diode module 21, collimators 22 and 23, a lens array 24, magnification lenses 25 and 26, and an LCoS (light crystal on silicon) panel 27, arranged in sequence with appropriate spacing in-between. The light-emitting diode module 21, as the light source, emits red, green, and blue primary lights. The collimators 22 and 23, in a front-back sequential arrangement with appropriate spacing, convert light from the light-emitting diode module 21 into collimated light. The lens array 24 homogenizes the collimated light. Preferably, the focus of each lens in the lens array 24 is 2 mm˜10 mm for superior effect. The magnification lenses 25 and 26, in a front-back arrangement with appropriate spacing, magnify the homogenized light from the lens array 24 with a predetermined ratio onto the LCoS panel 27. Please note that the focus of the former should be larger than that of the latter. The LCoS panel 27 reflects and modulates the light to produce an optic signal to be projected to a screen.

As illustrated in FIG. 2, the light source system 20 of the present invention is able to achieve a reduced volume than the conventional light source system. The collimators 22 and 23 are positive lenses to convert light from the light-emitting diode module 21 into collimated light. In addition, as the collimator 22 faces the light emitting diode module 21 by a flat surface, maximum amount of scattered light is collimated within a limited distance.

As illustrated in FIG. 2, the light source system 20 of the present invention, with the lens array 24 and positive-lens-based collimators 22 and 23, homogenizes the collimated light and projects the homogenized light onto the LCoS panel 27. The function of the lens array 24 is to partition incident collimated light into an array of secondary light sources. The light of each secondary light source in the array is magnified by the positive-lens-based magnification lenses 25 and 26 onto the LCoS panel 27. As the light from the secondary light sources is overlapped and thereby compensated by each other on the LCoS panel 27, enhanced brightness uniformity is achieved.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light source system of a pico projector, comprising a light-emitting diode module, collimators, a lens array, magnification lenses, and an LCoS (light crystal on silicon) panel, arranged in sequence with appropriate spacing in-between; wherein
said light-emitting diode module, as the light source to said light source system, emits red, green, and blue primary lights;
said collimators, in a front-back arrangement with appropriate spacing, convert light from said light-emitting diode module into collimated light;
said lens array homogenizes the collimated light;
said magnification lenses magnify the homogenized light from said lens array with a predetermined ratio onto said LCoS panel; and
said LCoS panel reflects and modulates said magnified light to produce an optic signal to be projected to a screen.

2. The light source system of a pico projector according to claim 1, wherein where said collimators are positive lenses; and, at least one of said collimators' surfaces facing said light emitting diode module is a flat surface so as to concentrate maximum amount of scattered light within a limited distance.

3. The light source system of a pico projector according to claim 1, wherein said magnification lenses utilizes positive lenses; and,
together with said lens array, said positive lenses uniformly project incident collimated light onto said LCoS panel.

4. The light source system of a pico projector according to claim 1, wherein the focus of each lens in said lens array is 2 mm˜10 mm.
